(19) United States
(12) Patent Application Publication
(10) Pub. No.: US 2020/0341164 A1
(43) Pub. Date: Oct. 29, 2020

(54) Metal Detector

(71) Applicants: James Blankenship, Graham, WA (US); Ryan Blankenship, Bonney Lake, WA (US)

(72) Inventors: James Blankenship, Graham, WA (US); Ryan Blankenship, Bonney Lake, WA (US)

(21) Appl. No.: 16/395,031

(22) Filed: Apr. 25, 2019

(51) Int. Cl. G01V 3/165; H04M 1/725; G08B 5/22; H04W 4/029

(52) U.S. Cl. CPC G01V 3/165; H04W 4/029; G08B 5/225; H04M 1/72533

(57) ABSTRACT

A metal detector may interface with a smartphone, tablet, or another similar device. The smartphone display may provide enhanced ways to provide information about received signals from the metal detector's coils. A smartphone's sensors, such as GPS, may also provide additional functionality to the metal detector.

### FIELD

This disclosure relates generally to the field of a metal detector.

### BACKGROUND

Metal detectors may be used for determining the presence and location of metal. For example, metal detectors may help users locate metal beneath the Earth's surface or contained within other matter. Ordinarily, metal detectors convey information to users about the proximity of metal in relation to the metal detector. However, there is variation in both the functionality and ways metal detectors work. As such, metal detectors have a range of price points. One factor contributing to higher costs for potential metal detector users is the way metal detectors convey information to users.

Over the years users have interacted with metal detectors in a variety of ways, but one common way has been an emission of a tone by the metal detector, which a user listens to through a set of headphones attached by a wire to the metal detector. The frequency and volume of the tone may indicate the type of metal detected and the strength of the signal detected. Although this generally remains a popular way for users to receive information, some metal detectors have added visual indicators to show the strength of the detected signal. In one of the simplest forms, an electro-mechanical needle is used to indicate the signal strength. User control over the electronics has typically been through adjustable dials. Liquid Crystal Displays (LCD) and Light Emitting Diode (LED) displays are also used to convey information, although these are generally fixed as to the types of information that can be displayed. Switches, push-buttons, membrane-keypads, and touch-sensitive buttons have become commonplace methods for users to select and control the capabilities of metal detectors.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a metal detector interface which may allow a connection with a smartphone, tablet, or another similar device.

Today's smartphones are powerful personal computers which not only have access to the Internet using both Wi-Fi and mobile broadband, but also have support for Bluetooth and Global Positioning Satellite (GPS) navigation. Touchscreen interfaces utilizing graphical interfaces are ubiquitous among modern smartphones, with the advantages associated with one user interface being able to both display and accept input from the user, along with easily being able to be reconfigured to accept user inputs in different ways. Instead of needing to provide specialized knobs, buttons, and manufacture different displays to add functionality to a smartphone, one merely needs to upload a program, or app, to the smartphone. The app can then be programmed with any user interface needed.

By coupling the powerful computing capabilities of a smartphone's onboard sensors (such as GPS, and magnetometer/compass), along with the advantages of the smartphone's color display and touchscreen interface with the electronic components of a metal detector, the capabilities of a metal detector can be greatly enhanced.

### BRIEF DESCRIPTION OF THE DRAWINGS

The present description may be better understood from the following detailed description read in light of the appended drawings, wherein:

FIG. 1 is an isometric view of a metal detector, according to one implementation.

FIG. 2 illustrates a user interface of a metal detector, according to one implementation.

FIG. 3 illustrates a user interface of a metal detector, according to another implementation.

FIG. 4 illustrates a user interface of a metal detector, according to another implementation.

FIG. 5 illustrates a user interface of a metal detector, according to another implementation.

FIG. 6 illustrates components of a metal detector, according to another implementation.

### DETAILED DESCRIPTION

A more particular description of certain implementations of a metal detector may be had by references to the implementations shown in the drawings that form a part of this specification, in which like numerals represent like objects.

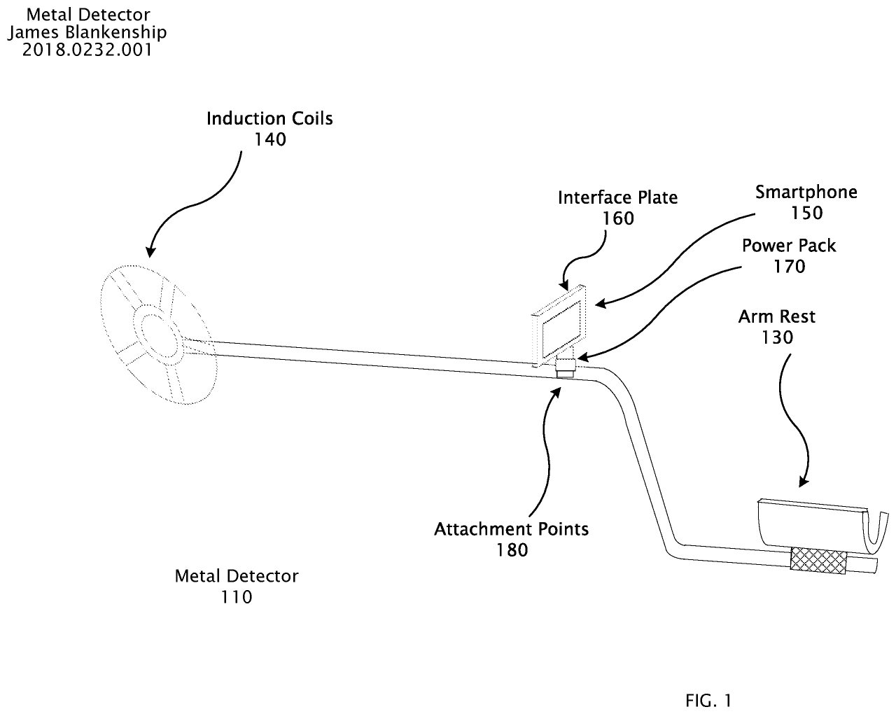

FIG. 1 is an isometric view of Metal Detector 110, according to one implementation. In this example, Metal Detector 110 may be comprised of Induction Coils 140, which may be comprised of one or more pieces of coiled wire through which an electric current may be passed, thereby creating a magnetic field through the process of induction. This magnetic field may then produce an electric current in a nearby metallic object, which in turn may induce a second magnetic field which is then detected by Induction Coils 140 through the production of an electric current induced in the coils. This signal may then be transferred to Smartphone 150, either through a wired connection plugging directly into Smartphone 150, or wirelessly via Wi-Fi, Near-Field Communication (NFC), Bluetooth, such as Bluetooth Low Energy (BLE), or a similar technology. Interface Plate 160 may be attached to Support Rod 120, providing a means by which Smartphone 150 may be mounted to Support Rod 120. Interface Plate 160 may be comprised of a Power Pack 170, which may provide power for Induction Coils 140, as well as provide power to wirelessly transmit information to Smartphone 150. It may also provide a recharging point for Smartphone 150. Interface Plate 160 may also be comprised of one or more Attachment Points 180 to securely hold Smartphone 150, a tablet, or any similar device. Support Rod 120 may be a straight rod or may be a curved shape and may, for example, have Arm Rest 130 mounted to the end opposite of Induction Coils 140.

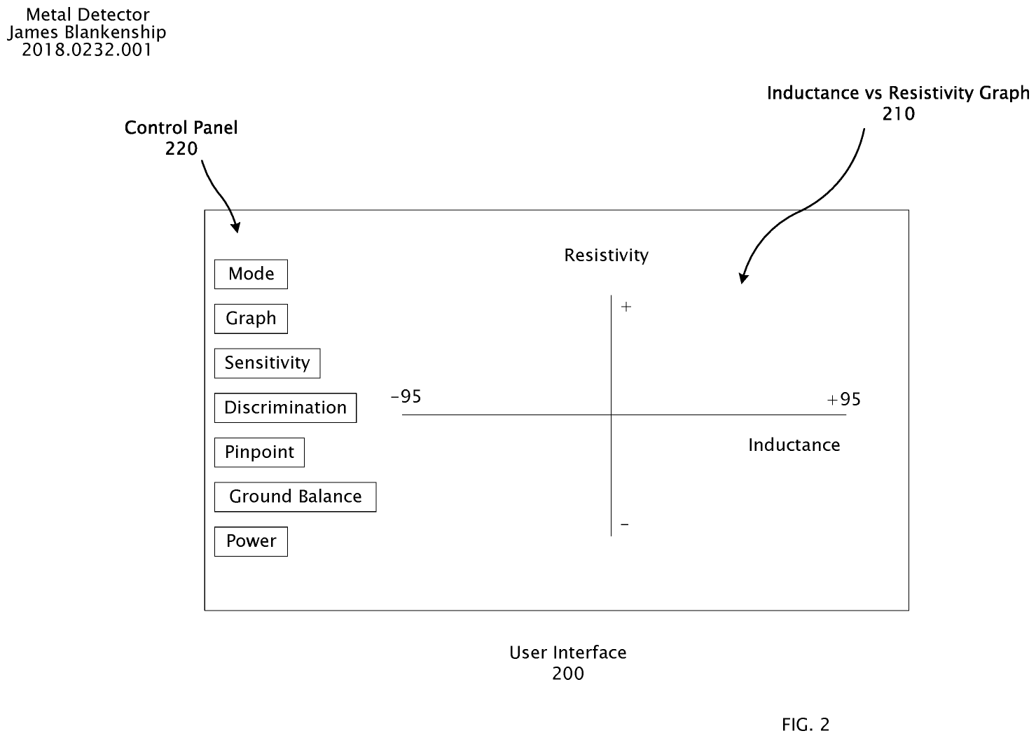

FIG. 2 illustrates User Interface 200 of Metal Detector 110. Metal detectors may distinguish metal objects from each other based on the ratio of the object's inductance to its resistivity. Inductance vs. Resistivity Graph 210 may provide a tool allowing the user to visualize in a graphical format how these qualities of metal relate to one another.

One having skill in the art will recognize that inductance and resistivity may be measured at various frequencies or from varying directions or distances to provide further information about a composition of a detected object.

Control Panel 220 may provide access to configure the user interface, as well as controlling settings for the metal detector.

One skilled in the art will recognize that the user interface elements described herein are just one potential combination of interface elements, and more or fewer elements may comprise the interface while still providing the same degree of functionality.

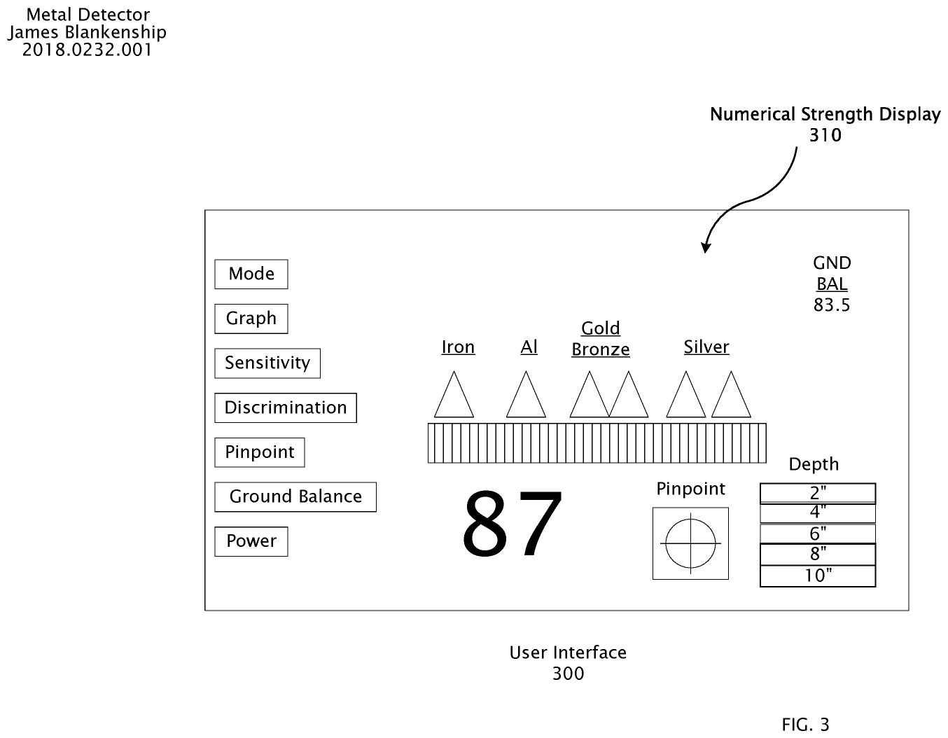

FIG. 3 illustrates User Interface 300 for Metal Detector 110 according to another implementation. Instead of plotting a metallic object's ration of inductance to its resistivity on a graph, Numerical Strength Display 310 may provide an alternative way for a user to detect metallic objects. Numerical Strength Display 310 may provide a numeric readout, along with a meter indication showing the target's likely identity, for example, iron, aluminum, gold/bronze, or silver. The interface may also include readouts providing the user with a numerical indication of the ground balance, along with a readout of the depth of the potential target under the ground, which may be displayed in either graphical form or in numeric format. One skilled in the art will recognize that the user interface elements described herein are just one combination of interface elements, and more or fewer elements may comprise the interface while still providing the same degree of functionality.

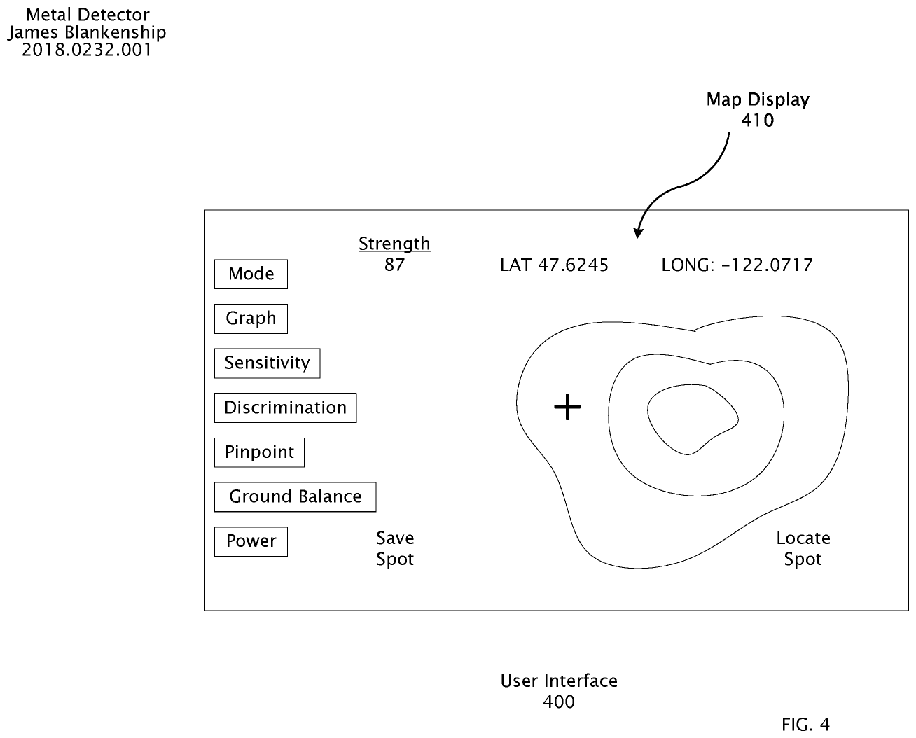

FIG. 4 illustrates User Interface 400 of Metal Detector 110 according to yet another implementation. Map Display 410 may provide a means for a user to detect metallic objects relative to geographic features surrounding the user. Map Display 410 may provide a top-down map view of the user's current search area. Numerical displays of the current latitude and longitude may be included which may provide the user with their exact position, based on Smartphone 150's Global Positioning System (GPS) sensors. Buttons may be provided which may allow a user to “mark” a geolocation that may be of interest to them, which may allow a user to conduct a survey of an area in order to identify specific locations the user may want to return to in order to investigate further, or alternatively to load a saved geolocation and provide the user's relative position so that the user may return to a previously saved spot. One skilled in the art will recognize that the user interface elements described herein are just one potential combination of interface elements, and more or fewer elements may comprise the interface while still providing the same degree of functionality.

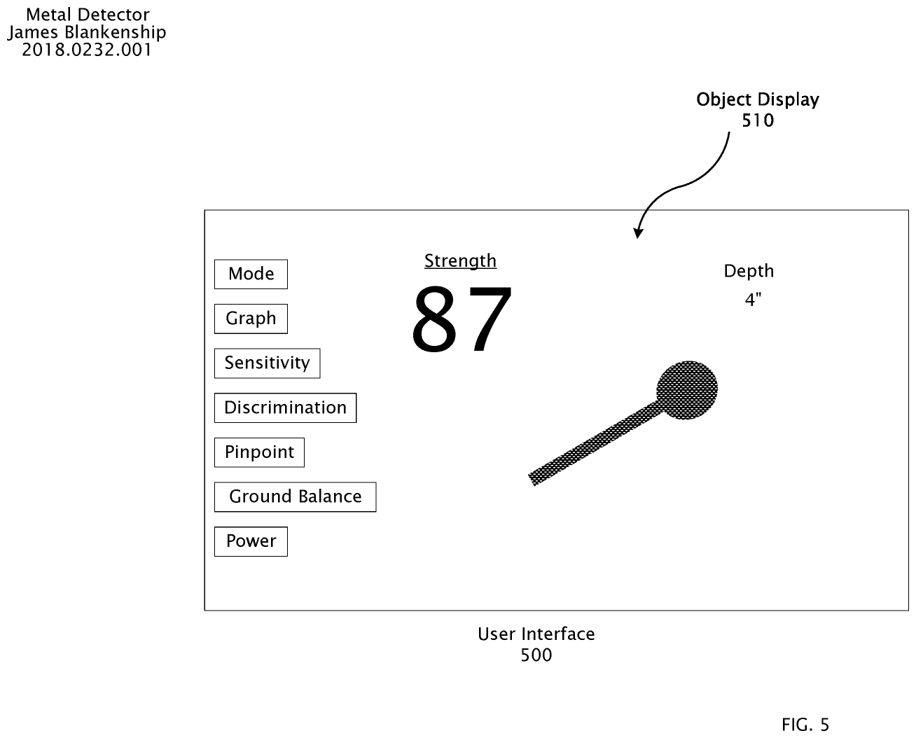

FIG. 5 illustrates User Interface 500 of Metal Detector 110 according to yet another implementation. Object Display 510 may provide an alternative means for a user to detect metallic objects. Object Display 510 may provide a representative image of a shape of an object being detected, based on the signal returned from the object as Metal Detector 110 is moved over the object from multiple directions. One skilled in the art will recognize that the user interface elements described herein are just one potential combination of interface elements, and more or fewer elements may comprise the interface while still providing the same degree of functionality.

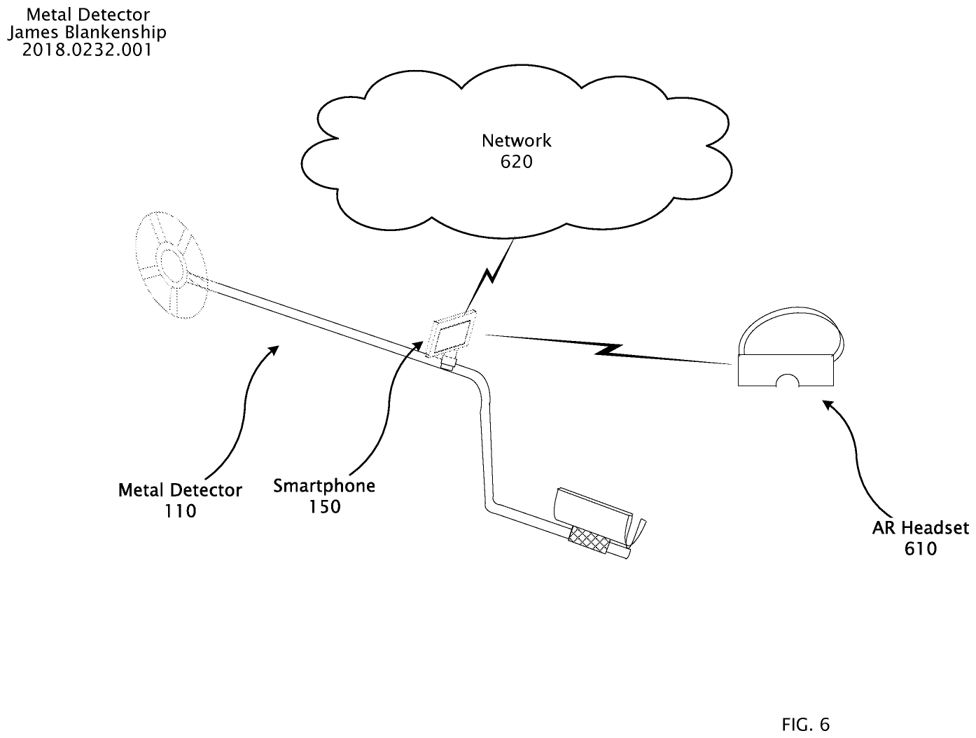

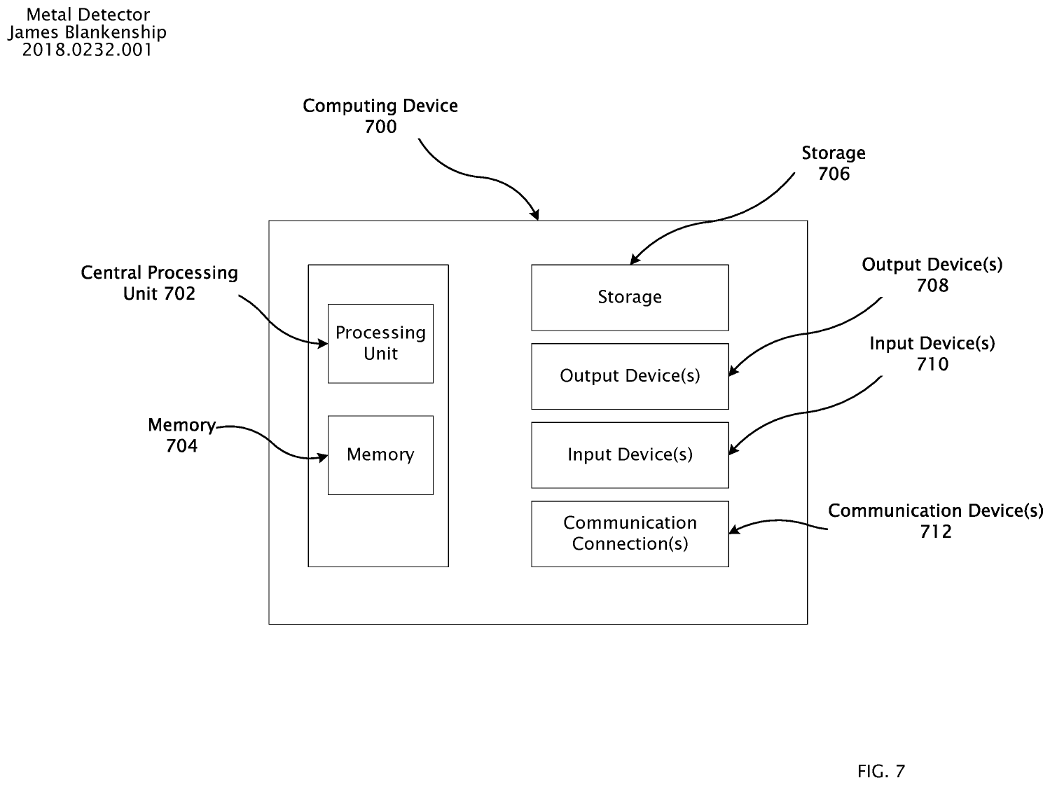

FIG. 6 illustrates a system which uses augmented reality in the field of metal detection. In this example, Metal Detector 110 may be connected to SmartPhone 150, either physically through a connector, or wirelessly through the use of Bluetooth, Wi-Fi, Near-Field Communications (NFC), or another communication technology. SmartPhone 150 may be connected to Augmented Reality (AR) Headset 610 through either a wired connection or wirelessly through the use of Bluetooth, Wi-Fi, NFC, or another communication technology. SmartPhone 150 may be capable of connecting wirelessly with Network 620, which may include Wi-Fi, cellular data access methods, such as 3G or 4GLTE, Bluetooth, Near Field Communications (NFC), the internet, local area networks, wide area networks, or any combination of these or other means of providing data transfer capabilities. AR Headset 610 may be a currently existing technology such as Microsoft HoloLens, Google Glass, Lenovo Mirage AR Headset, or another technology capable of superimposing information over a real-world environment, thereby allowing a user advantages of a computer display while still being able to see their surrounding physical environment. AR Headset 610 may allow a user to view information useful in the activity of metal detecting superimposed over the user's real-world environment, thereby allowing the user to maintain situational awareness of their surroundings while engaged in the search for buried objects.

FIG. 7 illustrates a component diagram of a computing device according to one embodiment. The Computing Device (700) may be utilized to implement one or more computing devices, computer processes, or software modules described herein, including, for example, but not limited to Smartphone 150. In one example, the Computing Device (700) can be utilized to process calculations, execute instructions, receive and transmit digital signals. In another example, the Computing Device (700) can be utilized to process calculations, execute instructions, receive and transmit digital signals, receive and transmit search queries, and hypertext, compile computer code as required by Smartphone 150. The Computing Device (700) can be any general or special purpose computer now known or to become known capable of performing the steps and/or performing the functions described herein, either in software, hardware, firmware, or a combination thereof.

In its most basic configuration, Computing Device (700) typically includes at least one Central Processing Unit (CPU) (702) and Memory (704). Depending on the exact configuration and type of Computing Device (700), Memory (704) may be volatile (such as RAM), non-volatile (such as ROM, flash memory, etc.) or some combination of the two. Additionally, Computing Device (700) may also have additional features/functionality. For example, Computing Device (700) may include multiple CPU's. The described methods may be executed in any manner by any processing unit in computing device (700). For example, the described process may be executed by multiple CPUs in parallel.

Computing Device (700) may also include additional storage (removable and/or non-removable) including, but not limited to, magnetic or optical disks or tape. Such additional storage is illustrated in FIG. 5 by Storage (706). Computer readable storage media includes volatile and nonvolatile, removable and non-removable media implemented in any method or technology for storage of information such as computer readable instructions, data structures, program modules or other data. Memory (704) and Storage (706) are all examples of computer storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can store the desired information and which can accessed by computing device (700). Any such computer-readable storage media may be part of computing device (700). But computer-readable storage media does not include transient signals.

Computing Device (700) may also contain Communications Device(s) (712) that allow the device to communicate with other devices. Communications Device(s) (712) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (700) may also have Input Device(s) (710) such as a keyboard, a mouse, a pen, a voice input device, a touch input device, or other devices. Output Device(s) (708) such as a display, speakers, a printer, or other devices may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

1. A metal detector, comprising:
an induction coil;
a power supply, the power supply providing power for the induction coil;
an interface plate operable to hold a smartphone; and
an interface operable to allow an output from the induction coil to be communicated to a smartphone.

2. The metal detector of claim 1, wherein the power supply is operable to power or charge the smartphone.

3. A method of providing information about metal, comprising:
receiving an inductance value from an induction coil;
receiving a resistivity value from the induction coil; and
displaying the inductance value or the resistivity value on a smartphone display.

4. The method of claim 3 wherein displaying the inductance value or the resistivity value comprises displaying a graph of the inductance value versus the resistivity value.

5. The method of claim 3 further comprising a representation of a shape of the metal.

6. The method of claim 3 wherein displaying the inductance value and the resistivity value comprises displaying a numeric readout of signal strength received at the induction coil.

7. The method of claim 3 further comprising displaying a map on the smartphone display, the map indicating a location of the metal.

8. The method of claim 3 further comprising displaying a type of metal detected.

9. A metal detector, comprising:
an induction coil;
a power supply, the power supply providing power for the induction coil;
a processor;
a memory operably coupled to the processor;
an augmented reality display, operable coupled to the processor; and
an interface operable to allow an output from the induction coil to be communicated to the augmented reality display.
